(19) United States
(12) Patent Application Publication
(10) Pub. No.: US 2017/0081565 A1
(43) Pub. Date: Mar. 23, 2017

(54) GENTLE TO SKIN (METH)ACRYLATE PRESSURE-SENSITIVE ADHESIVE

(71) Applicant: 3M INNOVATIVE PROPERTIES COMPANY, St. Paul, MN (US)

(72) Inventors: Joon Chatterjee, Bloomington, MN (US); Erick I. Soto Cantu, Woodbury, MN (US); Mark F. Ellis, St. Paul, MN (US); Babu N. Gaddam, Woodbury, MN (US); Scott P. Lundequam, Ham Lake, MN (US); Adam R. Wohl, Mahtomedi, MN (US)

(73) Assignee: 3M INNOVATIVE PROPERTIES COMPANY, St. Paul, MN (US)

(21) Appl. No.: 15/123,932

(22) PCT Filed: Feb. 25, 2015
(86) PCT No.: PCT/US2015/017489

§ 371 Date: Sep. 6, 2016

Related U.S. Application Data
(60) Provisional application No. 61/948,286, filed on Mar. 5, 2014.
(60) Provisional application No. 62/049,793, filed on Sep. 12, 2014.

(51) Int. Cl. C09J 133/08; C09J 5/00; C09J 7/02

(52) U.S. Cl. CPC C09J 133/08; C09J 7/0217; C09J 5/00; C08K 5/103

(57) ABSTRACT

A pressure-sensitive adhesive obtained from crosslinking a pre-adhesive composition comprising poly(meth)acrylate macromolecules that comprise a number-average molecular weight of from about 25000 to about 200000.

### BACKGROUND

Pressure-sensitive adhesive tapes are ubiquitous in the home and workplace. In one of its simplest configurations, a pressure-sensitive adhesive tape includes a pressure-sensitive adhesive (PSA) and a tape backing. Materials that have been found to function well as PSAs include polymers designed and formulated to exhibit the requisite viscoelastic properties resulting in a desired balance of tack, peel adhesion, and shear holding power. PSAs do not embrace compositions merely because they are sticky or adhere to a surface. Rather, the requirements for a PSA are assessed generally by means of tests designed to measure e.g., tack, peel strength, and shear strength, which properties taken together constitute the balance of properties often used to characterize a PSA.

### SUMMARY

In broad summary, herein is disclosed a pressure-sensitive adhesive obtained from crosslinking a pre-adhesive composition comprising poly(meth)acrylate macromolecules that comprise a number-average molecular weight of from about 25000 to about 200000. These and other aspects will be apparent from the detailed description below. In no event, however, should this broad summary be construed to limit the claimable subject matter, whether such subject matter is presented in claims in the application as initially filed or in claims that are amended or otherwise presented in prosecution.

### BRIEF DESCRIPTION OF THE DRAWINGS

FIG. 1 depicts dynamic-mechanical (DMA) data as obtained for various exemplary pre-adhesive compositions disclosed herein.

FIG. 2 depicts DMA data as obtained for various additional exemplary pre-adhesive compositions disclosed herein.

### DETAILED DESCRIPTION

### Definitions

As used herein, the term “pressure-sensitive adhesive” refers to a viscoelastic material that meets the well-known Dahlquist criterion (e.g., the storage modulus of the material at 25° C. is less than 3×10⁵ Pa at a frequency of 1 Hz).

As used herein, the term “pre-adhesive composition” refers to a collection of poly(meth)acrylate macromolecules of number-average molecular weight of about 25000 to 200000, optionally along with one or more ingredients such as e.g. plasticizers, tackifiers, solvents, stabilizers, processing aids, and so on. While a pre-adhesive composition may not necessarily exhibit pressure-sensitive properties, it can be crosslinked to provide a pressure-sensitive adhesive as disclosed herein.

As used herein, the term “(meth)acrylate” refers to an acrylate, methacrylate, or both. The term “(meth)acrylate” refers a monomer of formula CH₂═C(R¹)—(CO)—OR² where R² is an alkyl, heteroalkyl, alkenyl, or aryl (or, a monomer unit derived from such a monomer). An alkyl, heteroalkyl, or alkenyl R² group can be substituted with an aryl, aryloxy, halo, or a combination thereof. An aryl R² group can be substituted with an alkyl, heteroalkyl, halo, alkoxy, aryloxy, or a combination thereof. The term “alkyl (meth)acrylate” refers to a (meth)acrylate where R² is an alkyl group.

As will be appreciated by those of ordinary skill, terminology such as “consisting essentially of” a certain component, or such as being “substantially free of” of a particular material, does not preclude the presence of some extremely low, (i.e., 0.05 wt. % or less), amount of such material, as may occur e.g. when using large scale production equipment subject to customary cleaning procedures.

All parts and percentages disclosed herein are on a weight basis, unless otherwise indicated. All molecular weights (e.g., Mₙ) are in grams per mole.

Pressure-Sensitive Adhesive/Pre-Adhesive Composition

Pressure-sensitive adhesives (PSAs) and articles comprising such adhesives are disclosed herein. The pressure-sensitive adhesives contain a networked (meth)acrylate material prepared by crosslinking a pre-adhesive composition comprising poly(meth)acrylate macromolecules that comprise a number-average molecular weight of from about 25000 to about 200000. As will be appreciated from the disclosures herein, such pre-adhesive compositions can exhibit a unique rheology that provides the resulting PSAs with e.g. an enhanced ability to be removed from human skin with minimum perceived discomfort.

By “prepared by crosslinking a pre-adhesive composition”, by “the crosslinking reaction product of a pre-adhesive composition”, and similar terminology, is meant that a pre-adhesive composition (prepared e.g. from a first (meth)acrylate monomer mixture, in a first, synthesis reaction as described in detail later herein) is subjected to a crosslinking reaction in which at least some poly(meth)acrylate macromolecules of the pre-adhesive composition become covalently bonded to other macromolecules of the composition to form a polymer network that exhibits pressure-sensitive adhesive properties (noting that ingredients such as plasticizers and so on may be included to enhance the pressure-sensitive adhesive properties). Such a two-step process (i.e., the preparing of a pre-adhesive composition, and the subsequent crosslinking of such a composition), and the resulting pressure-sensitive adhesive product of such a process, can be distinguished from e.g. a polymer network that is built up from monomers/oligomers e.g. in a single synthesis process, as will be appreciated from the discussions herein.

By definition, the poly(meth)acrylate macromolecules of the pre-adhesive composition comprise a number average molecular weight (as may be determined e.g. by gel permeation chromatography using polystyrene standards as described in the Examples herein) of from about 25000 to about 200000 (grams per mole). As disclosed herein, it has been found that a molecular weight that is too low (e.g., below about 25000) may result in difficulty in crosslinking the pre-adhesive composition to form a suitable pressure-sensitive adhesive. Conversely, a molecular weight that is too high (e.g., above about 200000) may cause the crosslinked pressure-sensitive adhesive produced therefrom to exhibit a modulus that is too high (such that the PSA may e.g. lack optimum properties of tack and/or quick stick). In various embodiments, the poly(meth)acrylate macromolecules of the pre-adhesive composition may comprise a number average molecular weight of at least about 26000, 27000, 28000, 30000, or 32000. In further embodiments, the poly(meth)acrylate macromolecules of the pre-adhesive composition may comprise a number average molecular weight of at most about 110000, 100000, 80000, 60000, 40000, or 35000. All such molecular weights are below those of (meth)acrylate polymeric materials used in many conventional pressure-sensitive adhesives, with advantageous consequences as discussed herein. In some embodiments, the poly(meth)acrylate macromolecules may be essentially linear polymers (e.g., excepting such branching as may occasionally statistically occur in a polymerization reaction of (meth)acrylate monomers, e.g. monofunctional monomers.)

As documented in the Examples herein, the molecular weight of the macromolecules of a pre-adhesive composition (as well as the presence and/or amount of any plasticizer in the pre-adhesive composition) can have a significant impact on the modulus of the pre-adhesive composition, which can in turn have a significant effect on the properties of a PSA made therefrom. The pre-adhesive compositions disclosed herein have been found to exhibit a storage modulus in a range that helps provide advantageous properties (e.g., gentle release from skin) of the pressure-sensitive adhesives formed therefrom. By definition, the pre-adhesive composition exhibits a storage modulus of at most about 10000 Pa (as measured at 25° C., using procedures outlined in the Examples herein). In various embodiments the pre-adhesive composition may exhibit a storage modulus of at most about 7000, 4000 2000, 1000 or 500 Pa. In further embodiments the pre-adhesive composition may exhibit a storage modulus of at least about 4, 10, 20, 40, 80, 100, 200, or 400 Pa.

The pre-adhesive compositions as disclosed herein have been found to exhibit a glass transition temperature (T_{g}) that helps provide advantageous properties (e.g., gentle release from skin) of the pressure-sensitive adhesives formed therefrom. (For example, a lower T_{g} is often associated with a lower value of peel adhesion.) By definition, the pre-adhesive composition exhibits a T_{g} of at most about minus 20° C. (measured using procedures outlined in the Examples herein). In various embodiments the pre-adhesive composition may exhibit a T_{g} of at most about minus 30° C., minus 35° C., minus 40° C., or minus 45° C. In further embodiments the pre-adhesive composition may exhibit a T_{g} of at least about minus 60° C., minus 55° C., or minus 50° C.

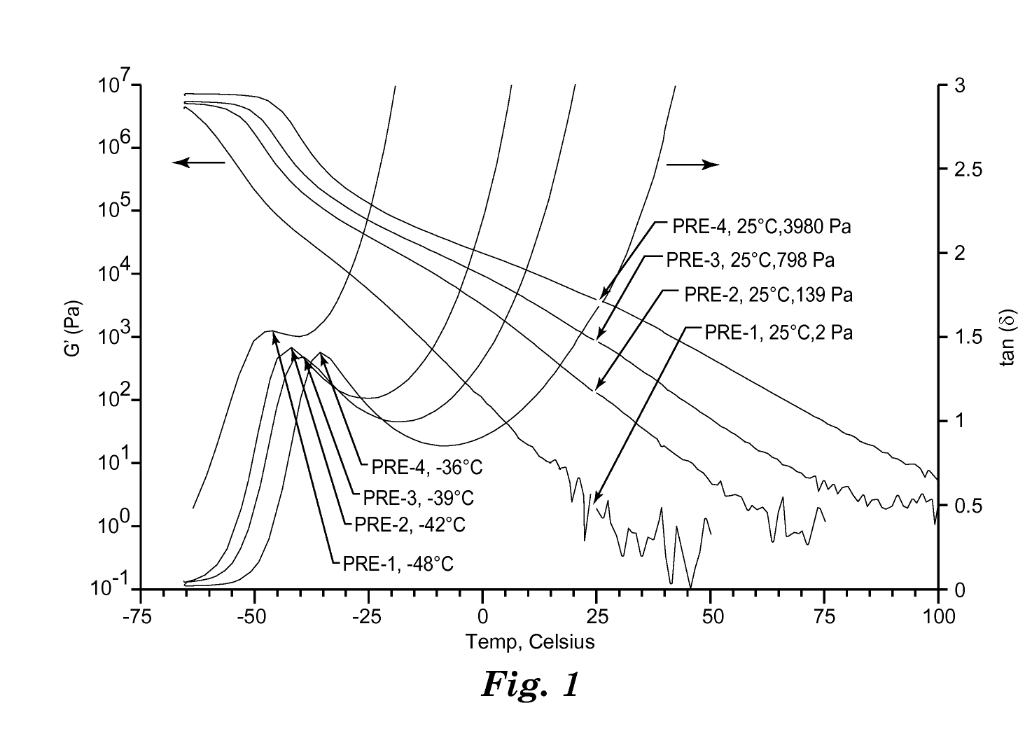

As demonstrated in the Examples herein, it has been found that the molecular weight of the poly(meth)acrylate macromolecules of the pre-adhesive composition can affect the T_{g} of the pre-adhesive composition. This can allow the T_{g} of the pre-adhesive composition to be tailored for optimum properties of the pressure-sensitive adhesive made therefrom. The ordinary artisan will appreciate that the molecular weights of the poly(meth)acrylate macromolecules disclosed herein are sufficiently high that it would be expected that properties such as T_{g} would have plateaued and thus would exhibit little change with molecular weight. For example, the poly(meth)acrylate macromolecules of Samples PRE-1, PRE-2, PRE-3, and PRE-4, comprise molecular weights that respectively correspond to a degree of polymerization (i.e., the average number of monomer units per macromolecular chain) in the range of about 130, 151, 187, and 300 (as noted in Table 3 of the Examples). These are all well over the threshold number of macromolecular chain atoms above which T_{g} is expected to be relatively insensitive to changes in molecular weight (see e.g. Rodriguez, Principles of Polymer Systems (2^{nd} Edition, 1982); Section 8-7, page 221). However, these samples respectively exhibited T_{g}s of minus 48° C., minus 42° C., minus 39° C., and minus 36° C. (as noted in Table 3 and FIG. 1). For comparison, the ordinary artisan would expect that the T_{g} of conventional poly(isooctyl acrylate), e.g. at a molecular weight of e.g. >200000-500000, would be in the range of minus 30° C. to minus 35° C., when measured by the same method. (The artisan would also expect such a material to exhibit a modulus that is significantly higher than the moduli exhibited by the materials described herein.) The discovery that the molecular weight of the poly(meth)acrylate macromolecules of the pre-adhesive composition can be used as a result-effective variable to affect the T_{g} of the pre-adhesive composition over the claimed range of molecular weight (and thus to affect the properties of the PSA made therefrom) is an unexpected result.

In some cases properties such as e.g. storage modulus and/or T_{g} may be primarily, or essentially completely, derived from the properties of the poly(meth)acrylate macromolecules of the pre-adhesive composition (e.g., in the event that the pre-adhesive composition consists essentially of the poly(meth)acrylate macromolecules). However, in some embodiments one or more plasticizers may be included in the pre-adhesive composition. In such embodiments, properties such as the storage modulus, T_{g}, and viscosity of the pre-adhesive composition may be significantly affected by the plasticizer. Thus, the amount and/or type of such a plasticizer may be conveniently chosen (e.g., in addition to the molecular weight of the poly(meth)acrylate macromolecules), to affect the properties of the pre-adhesive composition and of the PSA made therefrom, as documented in the Examples herein.

In embodiments in which one or more plasticizers are present in the pre-adhesive composition, they may be present at a wt. % (based on the total weight of the pre-adhesive composition) of at least about 2, 4, 8, 12, or 20. In further embodiments, such plasticizers may be present at a wt. % of at most about 50, 30, 20, 10, 4, 2, or 1. Any suitable plasticizer may be used as long as it does not unacceptably affect the properties of the pre-adhesive composition of the PSA made therefrom. Such a plasticizer may be optimally selected to be compatible with (i.e., miscible with) the other components in the pre-adhesive composition (e.g., the poly(meth)acrylate macromolecules). Potentially suitable plasticizers include various esters, e.g. adipic acid esters, formic acid esters, phosphoric acid esters, benzoic acid esters, phthalic acid esters; sulfonamides, and naphthenic oils. Other potentially suitable plasticizers include e.g. hydrocarbon oils (e.g., those that are aromatic, paraffinic, or naphthenic), vegetable oils, hydrocarbon resins, polyterpenes, rosin esters, phthalates, phosphate esters, dibasic acid esters, fatty acid esters, polyethers, and combinations thereof; plant fats and oils such as olive oil, castor oil, and palm oil; animal fats and oils such as lanolin; fatty acid esters of polyhydric alcohols such as a glycerin fatty acid ester and a propylene glycol fatty acid ester; and, fatty acid alkyl esters such as ethyl oleate, isopropyl palmitate, octyl palmitate, isopropyl myristate, isotridecyl myristate, and ethyl laurate, esters of a fatty acid. In particular embodiments, the plasticizer may be caprylic triglyceride. Any of the above plasticizers may be used alone or in combination (and/or in combination with any other additive mentioned herein); it will be appreciated that the above listings are exemplary and non-limiting. It will be appreciated that such a plasticizer or plasticizers will often remain in the PSA made from the pre-adhesive composition, so as to suitably enhance the properties thereof. Moreover, such plasticizer may be added to the pre-adhesive composition; or, it may be included in the monomer mixture (reaction mixture) from which the pre-adhesive composition is made, in which case the plasticizer may serve e.g. as a non-reactive diluent.

The poly(meth)acrylate macromolecules disclosed herein can include any suitable monomer unit(s). Suitable monomer units may be chosen from various non-polar (meth)acrylate monomer units including e.g. alkyl (meth)acrylates, alkenyl (meth)acrylates, aryl (meth)acrylates, aryl substituted alkyl (meth)acrylates, aryloxy substituted alkyl (meth)acrylates, and the like.

Alkyl (meth)acrylates include, but are not limited to, methyl (meth)acrylate, ethyl (meth)acrylate, n-propyl (meth)acrylate, isopropyl (meth)acrylate, n-butyl (meth)acrylate, isobutyl (meth)acrylate, n-pentyl (meth)acrylate, isopentyl (meth)acrylate (i.e., isoamyl (meth)acrylate), 3-pentyl (meth)acrylate, 2-methyl-1-butyl (meth)acrylate, 3-methyl-1-butyl (meth)acrylate, n-hexyl (meth)acrylate, isohexyl (meth)acrylate, 2-methyl-1-pentyl (meth)acrylate, 3-methyl-1-pentyl (meth)acrylate, 4-methyl-2-pentyl (meth)acrylate, 2-ethyl-1-butyl (meth)acrylate, 2-methyl-1-hexyl (meth)acrylate, 3,5,5-trimethyl-1-hexyl (meth)acrylate, cyclohexyl (meth)acrylate, 3-heptyl (meth)acrylate, n-octyl (meth)acrylate, isooctyl (meth)acrylate, 2-octyl (meth)acrylate, 2-ethyl-1-hexyl (meth)acrylate, n-decyl (meth)acrylate, isodecyl (meth)acrylate, 2-propylheptyl (meth)acrylate, isononyl (meth)acrylate, n-dodecyl (meth)acrylate (i.e., lauryl (meth)acrylate), n-tridecyl (meth)acrylate, isotridecyl (meth)acrylate, 3,7-dimethyl-octyl (meth)acrylate, 1-octadecyl (meth)acrylate, 17-methyl-1-heptadecyl (meth)acrylate, 1-tetradecyl (meth)acrylate, and the like.

Often, such monomer units are derived from monomers that are esters of either acrylic acid or methacrylic acid with non-tertiary alcohols. Specific examples of suitable monomers may include the esters of either acrylic acid or methacrylic acid with ethanol, 1-propanol, 2-propanol, 1-butanol, 2-butanol, 1-pentanol, 2-pentanol, 3-pentanol, 2-methyl-1-butanol, 3-methyl-1-butanol, 1-hexanol, 2-hexanol, 2-methyl-1-pentanol, 3-methyl-1-pentanol, 2-ethyl-1-butanol, 3,5,5-trimethyl-1-hexanol, 3-heptanol, 1-octanol, 2-octanol, isooctylalcohol, 2-ethyl-1-hexanol, 1-decanol, 2-propylheptanol, 1-dodecanol, 1-tridecanol, 1-tetradecanol, citronellol, dihydrocitronellol, and the like. Still other suitable non-polar (meth)acrylates are aryl (meth)acrylates such as, for example, phenyl (meth)acrylate or benzyl (meth)acrylate; alkenyl (meth)acrylates such as, for example, 3,7-dimethyl-6-octenyl-1 (meth)acrylate and allyl (meth)acrylate; and aryl substituted alkyl (meth)acrylates or aryloxy substituted alkyl (meth)acrylates such as, for example, 2-biphenylhexyl (meth)acrylate, benzyl (meth)acrylate, and 2-phenoxy ethyl (meth)acrylate. It will be understood that all of the above listings are exemplary and are non-limiting.

In some embodiments, the monomer units and poly(meth)acrylate macromolecules formed therefrom may be chosen from those monomer units and macromolecules described in U.S. Pat. No. 8,137,807 to Clapper, which is incorporated by reference in its entirety herein. In embodiments in which the pre-adhesive composition is to be photo-crosslinked to form the pressure-sensitive adhesive, the pre-adhesive composition may include photo-activatable crosslinkers provided by monomer units such as e.g. acryloylethoxybenzophenone, as discussed in detail later herein.

In many embodiments, it may be convenient that at least some of the monomer units be alkyl (meth)acrylate monomer units (many of which are included among the above exemplary listings). The size of the alkyl group (e.g., the number of carbon atoms thereof) may be chosen as desired. Particularly convenient alkyl (meth)acrylate monomers may include e.g. 2-ethylhexyl acrylate and isooctyl acrylate, both of which have an alkyl group with eight carbon atoms. In some embodiments, some or all of the poly(meth)acrylate macromolecules may be homopolymers; i.e., they may consist essentially of one particular type of monomer unit (as exemplified by the isooctyl acrylate homopolymers of the Working Examples). In other embodiments, various monomer units may be copolymerized with one or more different monomer units, as desired. In various embodiments, poly(meth)acrylate copolymer macromolecules may be random copolymers, or block copolymers.

In particular embodiments, some small amount of a high-T_{g} monomer unit (i.e., with a nominal T_{g} of at least about minus 20° C.) may be included in the poly(meth)acrylate macromolecules, e.g. in order to adjust the T_{g} (while remaining within the desired range disclosed herein). In various embodiments, such high-T_{g} monomers, if present, may exhibit a nominal T_{g} that is e.g. at least 0° C., at least 25° C., at least 30° C., at least 40° C., or at least 50° C. (It will be appreciated that when incorporated into the disclosed poly(meth)acrylate macromolecules e.g. at a few wt. %, such monomers will not exhibit this nominal T_{g}; rather, the nominal T_{g} will be understood to be that of the high-T_{g} monomer when polymerized by itself to form a homopolymer.) Suitable high T_{g} monomers include, but are not limited to, methyl methacrylate, tert-butyl methacrylate, ethyl methacrylate, n-propyl methacrylate, isopropyl methacrylate, isobutyl methacrylate, tert-butyl methacrylate, stearyl methacrylate, phenyl methacrylate, cyclohexyl methacrylate, isobornyl (meth)acrylate, benzyl methacrylate, 3,3,5-trimethylcyclohexyl acrylate, cyclohexyl methacrylate, or combinations thereof.

It has been found that a high level of polar monomer units can disadvantageously affect the skin-adhesion properties of the herein-disclosed PSA. By definition, the poly(meth)acrylate macromolecules of the pre-adhesive composition include less than about 1 wt. % of polar monomer units. In various embodiments, the poly(meth)acrylate macromolecules include less than about 0.4, 0.2, or 0.1 wt. % of polar monomer units. In particular embodiments, the poly(meth)acrylate macromolecules are substantially free of polar monomer units, meaning that they include less than about 0.05 wt. % of polar monomer units. Polar monomer units that are subject to such exclusions include, but are not limited to, the monomer units described in PCT International Publication Number WO2013/048735 to Lewandowski, on page 6 line 27 through page 7 line 31. In specific embodiments, the poly(meth)acrylate macromolecules are substantially free of (meth)acrylic acid monomer units, of acrylamide monomer units, of acrylonitrile monomer units, of 2-hydroxyethyl acrylate monomer units, and/or of glycidyl methacrylate monomer units.

Small amounts of other (e.g., non-(meth)acrylate) monomer units may also be included in the poly(meth)acrylate macromolecules, as long as they do not unacceptably affect the properties of the pre-adhesive composition or the PSA made therefrom. Thus, in some embodiments the poly(meth)acrylate macromolecules may be copolymers that further include one or more other vinyl monomer units such as vinyl esters (e.g., vinyl acetate and vinyl propionate); styrene or derivatives thereof such as alkyl substituted styrene (e.g., alpha-methyl styrene); vinyl halides; or mixtures thereof. If present, these other vinyl monomer units can be present in any suitable amount. In some embodiments, the vinyl monomer units are present in an amount of up 5, 2, 1, or 0.5 wt. % of the poly(meth)acrylate macromolecules. However, in some embodiments the poly(meth)acrylate macromolecules are substantially free of non-(meth)acrylate vinyl monomer units. In particular embodiments, the poly(meth)acrylate macromolecules may be comprised of at least about 90, 95, 98, 99, 99.5, or 99.8 wt. % nonpolar alkyl (meth)acrylate monomer units that do not include any heteroatoms.

In various embodiments the poly(meth)acrylate macromolecules may make up at least about 60, 80, 90, 95, 98, 99, 99.5, or 99.8 wt. % of the macromolecular components (e.g., those components with an average molecular weight of over 2000) of the pre-adhesive composition. In further embodiments, the poly(meth)acrylate macromolecules may make up at least about 60, 80, 90, 95, 98, 99, 99.5, or 99.8 wt. % of the total components of the pre-adhesive composition. In some embodiments, the pre-adhesive composition (and the PSA made therefrom) can include optional components such as, for example, pigments, glass beads, polymer beads (e.g., expandable beads or expanded beads), mineral fillers such as e.g. silica, calcium carbonate, and the like, fire retardants, antioxidants, and stabilizers and so on. In some embodiments, the pre-adhesive composition (and the PSA made therefrom) can include one or more hydrocolloids (e.g., carboxymethyl cellulose, gelatin, pectin, croscarmellose sodium, and the like). In various embodiments, such a hydrocolloid or hydrocolloids can be present (in total) at least at about 0.5, 1, 5, or 10 wt. % of the PSA. In further embodiments, such a hydrocolloid or hydrocolloids can be present (in total) at most at about 35, 25, or 15 wt. % of the PSA

Any of these optional components can be added in any amount sufficient to obtain the desired properties, as long as they do not unacceptably interfere with the properties and functioning of the pre-adhesive composition and the PSA made therefrom. In general, with respect to polar components (including not only the previously-discussed polar monomer units, but also e.g. any hydrocolloids, plasticizers, fillers, thickeners, wetting agents, and so on, that may be polar in nature), the pre-adhesive composition and the PSA made therefrom may, in various embodiments, have polar components that are present (in total) at less than about 5, 2, 1, 0.5, 0.2, 0.1, 0.05, or 0.01% wt. %.

In some embodiments, the pre-adhesive composition (and the PSA made therefrom) can optionally include at least one tackifier. Suitable tackifiers and amounts in which they may be present in a PSA are discussed in detail in PCT International Publication Number WO2013/048735 to Lewandowski, on page 13 line 22 through page 15 line 12. In particular embodiments the pre-adhesive composition includes less than about 2, 1, 0.4, 0.2, or 0.1 wt. % tackifier.

In some embodiments, the pre-adhesive composition (and the PSA made therefrom) can optionally include any suitable antimicrobial agent, disinfectant, bactericide, preservative, or the like.

Methods of Making

In general, the methods disclosed herein include at least the crosslinking of a pre-adhesive composition comprised of poly(meth)acrylate macromolecules that comprise a number-average molecular weight of from about 25000 to about 200000, to form a pressure-sensitive adhesive. In at least some embodiments, the methods also include a first, synthesis reaction in which a first, monomer mixture (reaction mixture) comprising (meth)acrylate monomers is polymerized to form the poly(meth)acrylate macromolecules of the pre-adhesive composition. (The term “monomer mixture” is used for convenience and it will be understood that such a mixture is not limited to monomers but rather may include e.g. one or more of initiators, chain transfer agents, solvents, plasticizers, and so on).

A first, synthesis reaction to form at least the poly(meth)acrylate macromolecules of the pre-adhesive composition can be carried out in any suitable manner. For example, desired amounts of one or more (meth)acrylate monomers (as described above) may be placed into a reaction vessel, along with any desired initiator, solvent, and the like, and the synthesis reaction carried out. Suitable initiators may include e.g. any thermal initiator, photoinitiator, or both, and can be present in any suitable amount. Suitable thermal initiators may be chosen e.g. from well-known peroxides and/or from aliphatic azo compounds such as e.g. azobisisobutyronitrile (AIBN) and derivatives thereof (many such thermal initiators are available from DuPont under the trade designation VAZO). Suitable photoinitiators may be chosen from e.g. products available from Ciba under the trade designation IRGACURE. Further details of various thermal initiators and photoinitiators that may be used in the polymerization of (meth)acrylate and like monomers are discussed in PCT International Publication Number WO2013/048735 to Lewandowski, on page 11 line 21 through page 12 line 19.

If a thermal initiator is used, the first, synthesis reaction may be initiated e.g. by heating the reaction mixture to a temperature sufficient to activate the thermal initiator. If a photoinitiator is used, the reaction mixture may be exposed to e.g. UV or visible light using any suitable photo-irradiation source (e.g., UV-bulbs and the like). As will be appreciated from the Examples herein, the amount of initiator used (e.g. in relation to the amount of polymerizable monomer present) may affect the degree of polymerization/molecular weight of the resulting poly(meth)acrylate macromolecules and thus the amount of initiator may thus be conveniently used as a result-effective variable to affect those parameters.

In some embodiments, the monomer mixture (reaction mixture) for the first, synthesis reaction may include at least one chain transfer agent. As will be evident from the Examples herein, a chain transfer agent can be used to help control the degree of polymerization/molecular weight of the resulting poly(meth)acrylate macromolecules as desired. Examples of useful chain transfer agents include, but are not limited to, carbon tetrabromide, alcohols, mercaptans such as isooctylthioglycolate, and mixtures thereof. If a chain transfer agent is used, the reaction mixture may include up to 0.5 weight percent of a chain transfer agent based on the total weight of polymerizable material. In various embodiments, the reaction mixture for the first, synthesis reaction can contain 0.01 to 0.5 weight percent, 0.05 to 0.5 weight percent, or 0.05 to 0.2 weight percent chain transfer agent. It will be appreciated that if a chain transfer agent is used, at least some of the poly(meth)acrylate macromolecules may exhibit at least one chain transfer agent residue (with the term “residue” denoting a moiety of the macromolecule that is identifiable as having come from a chain transfer agent).

In some embodiments, the reaction mixture for the first, synthesis reaction can optionally contain any suitable amount of organic solvent. In various embodiments, the reaction mixture may comprise less than 2, 1, 0.4, 0.2, or 0.1 wt. % solvent (based on the total weight of the reaction mixture). In some embodiments, the reaction mixture for the first, synthesis reaction may be substantially free of organic solvent. If an organic solvent is used, it may be chosen from any suitable solvent, e.g. methanol, tetrahydrofuran, ethanol, isopropanol, heptane, acetone, methyl ethyl ketone, methyl acetate, ethyl acetate, toluene, xylene, and ethylene glycol alkyl ether. Such solvents can be used alone or as mixtures thereof. If present, a solvent may remain in the pre-adhesive composition to facilitate further processing (e.g. to reduce the viscosity to facilitate e.g. coating the composition onto a substrate); or, the solvent may be removed after the polymerization is complete so that the resulting pre-adhesive composition has a reduced amount of solvent (e.g. may be substantially free of organic solvent). As noted earlier, one or more plasticizers may also be included in the pre-adhesive composition, and may similarly serve to reduce the viscosity of the pre-adhesive mixture (while remaining in the final PSA product rather than being removed after coating in the manner of a solvent).

The pre-adhesive compositions as disclosed herein, comprising poly(meth)acrylate macromolecules of unconventionally low molecular weight, may advantageously comprise relatively low viscosities (e.g. at 25° C.). This may allow at least some such compositions to be coated even at a very low solvent content, or even e.g. when the composition is substantially free of solvent. While in some cases such coating might be done at room temperature, in other cases the composition might be heated (e.g. in the manner of a hot-melt coating composition) to facilitate the coating operation. In various embodiments, the pre-adhesive composition may exhibit an average viscosity of no more than about 4000, 1600, 800, 400, 200, 100, 50, 20, or 10 Pa·s at 25° C. In further embodiments, any of these viscosities may be exhibited by a pre-adhesive composition that is substantially free of solvent.

In some embodiments, reaction mixtures, conditions, and procedures may be employed that allow the first, synthesis reaction to be performed in an environment that uses a lower amount of solvent (e.g. volatile solvent) or may even be substantially free of such solvent. Such approaches may use e.g. the general methods and compositions discussed in U.S. Pat. Nos. 5,637,646, 5,753,768, 5,986,011, 7,691,437 and 7,968,661 to Ellis, and in PCT Published Application WO2014/078123 to Kurian, all of which are incorporated by reference herein. If desired, a non-reactive diluent (e.g. a non-volatile plasticizer) may however be present. Moreover, even if the pre-adhesive mixture is made in a solventless environment, some (e.g. small) amount of solvent may be added to the pre-adhesive composition e.g. to facilitate coating the composition on a substrate if desired. As defined herein, a solventless composition (e.g., a reaction mixture, a coating mixture, or, specifically, a pre-adhesive composition) is a composition that comprises less than about 0.2% by weight of any volatile solvent (which category does not include e.g. plasticizers, chain-transfer agents, initiators, processing aids, or any other ingredient that remains in the final PSA product).

The pre-adhesive composition may be disposed on (e.g., coated on) any suitable substrate and crosslinked to form the PSA product. The pre-adhesive composition can be coated using any conventional coating techniques modified as appropriate to the particular substrate. For example, the composition can be applied to a variety of solid substrates by methods such as roller coating, flow coating, dip coating, spin coating, spray coating, knife coating, and die coating. The resulting PSA may have any suitable thickness (e.g., final thickness, after crosslinking, and removal of any solvent if present). In some embodiments, the thickness of the pressure-sensitive adhesive layer is at least 12 μm or at least 25 μm. In various embodiments, the pressure-sensitive adhesive layer has a thickness no greater than 1200 μm, 500 μm, 250 μm, 125 μm, 100 μm, 75 μm, or 50 μm. In particular embodiments in which the coated pre-adhesive layer is crosslinked by photo-irradiation (as discussed below), it may be advantageous to coat the layer at a (dry) coating thickness of no more than about 50, 40, 30, or 20 microns.

As disclosed herein, the pre-adhesive composition is crosslinked (in a second, crosslinking reaction) to form a pressure-sensitive adhesive. Often, it is convenient to perform such crosslinking on the pre-adhesive composition after it has been coated as a layer onto a major surface of a desired substrate as noted above. It has been found that crosslinking of the herein-disclosed pre-adhesive composition (specifically, of the poly(meth)acrylate macromolecules thereof) can result in a pressure-sensitive adhesive that is extremely gentle to human skin and yet that has sufficient cohesive strength and other properties to function well as a pressure-sensitive adhesive for e.g. skin-bonding applications. The extent of crosslinking can be characterized by the gel content (percent gel) of the pressure-sensitive adhesive. (As obtained as described in the Examples herein, the gel content is a measure of the insoluble (networked) polymeric material that remains after extraction of soluble content). In various embodiments, the gel content of pressure-sensitive adhesive obtained from crosslinking of the poly(meth)acrylate macromolecules of the pre-adhesive composition, may be at least about 10, 20, 30, 40, or 50%. In further embodiments, the gel content of the pressure-sensitive adhesive may be at most about 90, 80, 70, or 65%. (It will be understood that gel content is a characterization of the macromolecular components of a composition and that in particular embodiments in which solvent, plasticizer, and so on, are present in the reaction product (e.g., in the PSA product), such components will be not be included in assessing gel content.)

In some embodiments, it may be convenient to perform the crosslinking by electron beam (ebeam). The ebeaming may be performed using any suitable apparatus, as are widely available. The ebeaming may be performed at any suitable conditions, e.g. combination of operating voltage (e.g., in kV) and dose (e.g., in Megarads). The ordinary artisan will appreciate that ebeaming is a mode of crosslinking in which high energy electrons interact with molecules in a generally non-specific manner to generate e.g. free radicals that may then form covalent bonds with other macromolecules. It will be thus be understood that such methods fall into a first general class of PSA production methods in which a crosslinking reaction is triggered in a non-specific manner (e.g. by a high energy electron) that may activate a macromolecule for crosslinking at any location along the macromolecular chain and that may not necessarily leave a specific residue (chemical signature) at the crosslink site. It will be appreciated that the use of ebeam to promote the second, crosslinking reaction can allow any suitable initiation mechanism (e.g., thermal initiation or photo-initiation) to be used to initiate the first, synthesis reaction.

In some embodiments, it may be convenient to perform the crosslinking of the pre-adhesive composition by photo-crosslinking. Such approaches involve photo-irradiating the pre-adhesive composition with (non-ionizing) electromagnetic radiation in a wavelength range of e.g. 100-500 nm (such processes are often referred to e.g. as UV-curing, light-curing, and so on). This may be performed using any suitable apparatus (as are widely available), and may be performed at any suitable conditions, e.g. combination of wavelength, dose rate, and so on.

To facilitate such approaches, the pre-adhesive composition (specifically, the macromolecules that make up the pre-adhesive composition) may include one or more photo-crosslinkers. This may be conveniently achieved by including one or more photo-crosslinkers (by which is meant a molecule that includes both a photo-activatable moiety and a (meth)acrylate moiety) in the monomer mixture used in the first, synthesis reaction to make the pre-adhesive composition. Such molecules may thus be incorporated (by way of their (meth)acrylate functionality) into the macromolecular chains of the pre-adhesive composition during the first, synthesis reaction. The pre-adhesive composition may then be coated as a layer onto a suitable substrate. The photo-activatable moieties of at least some of the photo-crosslinker molecules may then be activated by photo-irradiating the coated layer. This will generate e.g. free radicals that may then form covalent bonds with other macromolecules so as to crosslink the pre-adhesive composition to form a pressure-sensitive adhesive.

In contrast to the non-specific generation of free radicals that typically results from impinging high energy electrons onto macromolecules, in photo-irradiation the initiation of a free radical will typically occur specifically by decomposition of the photo-activatable moiety of the photo-crosslinker. It will thus be understood that photo-irradiation methods fall into a second general class of PSA production methods in which a crosslinking reaction is triggered by activation of a specific functional entity (e.g., the photo-activatable moiety of the photo-crosslinker). That is, a specifically identifiable residue (chemical signature) of a photo-activatable crosslinker may be observable in the macromolecules of the product PSA—for example, if the photo-activatable crosslinker is e.g. a benzophenone, the macromolecules of the resulting pressure-sensitive adhesive may exhibit detectable benzophenone residues.

Any suitable photo-activatable crosslinker may be used, as provided e.g. by way of any molecule that has dual functionality provided by a (meth)acrylate polymerizable moiety and a photo-activatable moiety. One such suitable molecule is acryloylethoxybenzophenone. Other potentially suitable molecules may include e.g. methacryloylethoxybenzophenone, acryloylbenzophenone, and methacryloylbenzophenone. Any such photo-activatable crosslinker may be provided in the reaction mixture used in the first, synthesis reaction, in any suitable amount. In particular embodiments, the photo-activatable crosslinker may be present at no more than about 1.2, 1.0, 0.8, 0.6, 0.4, or 0.2 wt. %, based on the total weight of the acrylate polymerizable monomers in the first, synthesis reaction mixture. In further embodiments, the photo-activatable crosslinker may be present at least at about 0.05, 0.1, 0.15, 0.2, or 0.3 wt. %.

It will also be understood that when a pre-adhesive composition is to be photo-crosslinked, it may be advantageous to initiate the first, synthesis reaction in some other way than by photo-initiation (for example, the first, synthesis reaction could be thermally initiated). This can help to minimize any chance of a photo-activatable crosslinker being activated prematurely, during the first synthesis reaction.

Tape Articles

The pre-adhesive composition can be disposed on (e.g. coated on) a major surface of any suitable substrate and crosslinked to provide a pressure-sensitive adhesive (PSA) layer as described above. Such a substrate may be a tape backing upon which the coated layer (after crosslinking as described below) will remain as a PSA attached thereto. If the back surface of the tape backing has release properties, the tape may be provided in the form of a self-wound roll. Suitable polymeric substrates (e.g., tape backings) include, but are not limited to, polymeric films such as those prepared from polypropylene, polyethylene, polyvinyl chloride, polyester (polyethylene terephthalate or polyethylene naphthalate), polycarbonate, polymethyl(meth)acrylate (PMMA), cellulose acetate, cellulose triacetate, and ethyl cellulose. Foam backings may be used if desired. In alternative embodiments, the substrate onto which the pre-adhesive composition is coated may be a release liner, so that a liner/PSA stack is formed. In such a case, the major surface of the PSA opposite the release liner may then be contacted with (bonded to) a tape backing to form an adhesive tape (with the release liner being removable during use of the tape). Such a product might be provided as a roll of adhesive tape or as discrete lengths of adhesive tape. In some embodiments, the substrate onto which the pre-adhesive composition is coated may be a sacrificial substrate (e.g. a temporary carrier) onto which the composition is coated (and e.g. crosslinked) and from which the resulting PSA is then transferred to a tape backing.

Compositions disclosed herein may display advantageous properties (e.g., gentle release from skin, and/or the ability to be debonded from e.g. skin and rebonded thereto with minimal loss of pressure-sensitive adhesive properties) while relying on relatively inexpensive materials such as (meth)acrylates (and plasticizer, if present). Compositions disclosed herein may also exhibit satisfactory, or even excellent, moisture-vapor transmission even while containing little or no polar monomer units and/or additives. While applications such as bonding to skin, e.g. human skin, have been discussed herein, and the compositions disclosed herein exhibit properties that make them particularly advantageous for such uses, it will be understood that these are non-limiting examples and that the pre-adhesive compositions disclosed herein, the PSAs made therefrom, can be used for any desired application, whether in the areas of consumer use, industrial use, or elsewhere. Furthermore, such compositions are not limited to being made by the particular exemplary methods disclosed herein (e.g. a first, synthesis reaction of the particular type described above).

Peel Adhesion

Certain aspects of the performance of a pressure-sensitive adhesive as disclosed herein may be characterized by way of a Peel Adhesion test (i.e., a 180° Peel Adhesion Test, measured as disclosed in the Examples herein). For such purposes the PSA may be conveniently provided on (e.g., deposited onto using e.g. methods disclosed herein) a conventional tape backing, e.g. a nonwoven backing of the general type used in the product available in 2014 from 3M Company, St. Paul Minn. under the trade designation KIND REMOVAL SILICONE TAPE. If the Peel Adhesion of an existing pressure-sensitive adhesive tape (i.e., a PSA already on a tape backing) is to be evaluated, the test may of course be performed on the adhesive tape as supplied. In various embodiments, a pressure-sensitive adhesive and/or a pressure-sensitive adhesive tape as disclosed herein may exhibit a Peel Adhesion of at most about 400, 300, 240, or 200 grams per inch. In further embodiments, a pressure-sensitive adhesive and/or a pressure-sensitive adhesive tape as disclosed herein may exhibit a Peel Adhesion of at least about 50, 100, 140, or 180 grams per inch. In at least some embodiments, a pressure-sensitive adhesive and/or a pressure-sensitive adhesive tape as disclosed herein will not exhibit cohesive failure during a Peel Adhesion test. The ordinary artisan will understand this to mean that the adhesive layer will part (debond) from the test substrate at the interface between the adhesive layer and the test substrate rather than the adhesive layer splitting or otherwise leaving significant residue behind on the test substrate. (In other words, the ordinary artisan will appreciate that the debonding occurs by way of separation of the surface of the adhesive layer from the surface of the test substrate and will thus appreciate that the condition that cohesive failure does not occur, may alternatively be phrased that the PSA exhibits “interfacial debonding” in a Peel Adhesion test).

### LIST OF EXEMPLARY EMBODIMENTS

Embodiment 1 is a pressure-sensitive adhesive, comprising the crosslinking reaction product of a pre-adhesive composition comprising poly(meth)acrylate macromolecules that comprise a number-average molecular weight of from about 25000 to about 200000, wherein the pre-adhesive composition exhibits a T_{g} of less than about minus 20° C., exhibits a storage modulus of from about 4 Pa to about 10000 Pa at 25° C., and wherein the pressure-sensitive adhesive exhibits a peel adhesion of from about 50 g/inch to about 400 g/inch.

Embodiment 2 is the adhesive of embodiment 1 wherein the poly(meth)acrylate macromolecules comprise a number-average molecular weight of from about 25000 to about 100000. Embodiment 3 is the adhesive of embodiment 1 wherein the poly(meth)acrylate macromolecules comprise a number-average molecular weight of from about 25000 to about 40000. Embodiment 4 is the adhesive of any of embodiments 1-3 wherein the pre-adhesive composition exhibits a storage modulus of from about 100 Pa to about 1000 Pa. Embodiment 5 is the adhesive of any of embodiments 1-4 wherein the pressure-sensitive adhesive exhibits a peel adhesion of from about 100 g/inch to about 240 g/inch. Embodiment 6 is the adhesive of any of embodiments 1-5 the pre-adhesive composition exhibits a T_{g} of less than about minus 45° C. Embodiment 7 is the adhesive of any of embodiments 1-6 wherein the pre-adhesive composition exhibits a viscosity from about 10 Pa·s to about 800 Pa·s at 25° C.

Embodiment 8 is the adhesive of any of embodiments 1-7 wherein the poly(meth)acrylate macromolecules make up at least about 95 wt. % of the macromolecular components of the pre-adhesive composition. Embodiment 9 is the adhesive of any of embodiments 1-8 wherein the poly(meth)acrylate macromolecules make up at least about 70 wt. % of the total components of the pre-adhesive composition. Embodiment 10 is the adhesive of any of embodiments 1-9 wherein the poly(meth)acrylate macromolecules consist essentially of nonpolar (meth)acrylate monomer units with a T_{g} of less than 0° C. Embodiment 11 is the adhesive of any of embodiments 1-10 wherein the poly(meth)acrylate macromolecules consist essentially of alkyl (meth)acrylate monomer units. Embodiment 12 is the adhesive of any of embodiments 1-11 wherein the poly(meth)acrylate macromolecules of the pre-adhesive composition are substantially linear macromolecules. Embodiment 13 is the adhesive of any of embodiments 1-12 wherein the pre-adhesive composition further comprises from about 4 wt. % to about 30 wt. % of a plasticizer, based on the total weight of the pre-adhesive composition. Embodiment 14 is the adhesive of any of embodiments 1-13 wherein the poly(meth)acrylate macromolecules are the reaction product of a first, synthesis reaction of a monomer mixture that included at least one chain transfer agent and wherein at least some of the poly(meth)acrylate macromolecules include at least one chain transfer agent residue. Embodiment 15 is the adhesive of any of embodiments 1-14 wherein the pressure-sensitive adhesive exhibits a gel content of from about 40 to about 70%.

Embodiment 16 is the adhesive of any of embodiments 1-15 wherein the pressure-sensitive adhesive is an e-beam crosslinking reaction product of the pre-adhesive composition. Embodiment 17 is the adhesive of any of embodiments 1-15 wherein the pressure-sensitive adhesive is a photo-crosslinking reaction product of the pre-adhesive composition and wherein at least some of the poly(meth)acrylate macromolecules of the crosslinked reaction product include at least one photo-activatable crosslinker residue. Embodiment 18 is the adhesive of any of embodiments 1-17 wherein the pressure-sensitive adhesive exhibits interfacial debonding in a Peel Adhesion test.

Embodiment 19 is a pressure-sensitive adhesive tape comprising a backing with a pressure-sensitive adhesive disposed on a major surface thereof, wherein the pressure-sensitive adhesive is the crosslinking reaction product of a pre-adhesive composition comprising poly(meth)acrylate macromolecules that comprise a number-average molecular weight of from about 25000 to about 200000, wherein the pre-adhesive composition exhibits a T_{g} of less than about minus 20° C. and exhibits a storage modulus of from about 4 Pa to about 10000 Pa at 25° C., and wherein the pressure-sensitive adhesive tape exhibits a peel adhesion of from about 50 g/inch to about 400 g/inch.

Embodiment 20 is the pressure-sensitive adhesive tape of embodiment 19 wherein the pressure-sensitive adhesive is in the form of a layer with an average thickness of about 130 microns or less. Embodiment 21 is a method of bonding a pressure-sensitive adhesive tape to skin, the method comprising applying the pressure-sensitive adhesive of the pressure-sensitive adhesive tape of any of embodiments 19-20 to skin.

Embodiment 22 is a method of making a pressure-sensitive adhesive, the method comprising: crosslinking a pre-adhesive composition comprised of poly(meth)acrylate macromolecules that comprise a number-average molecular weight of from about 25000 to about 200000, which pre-adhesive composition exhibits a T_{g} of less than about minus 20° C. and a storage modulus of from about 4 to about 10000 Pa at 25° C., to form a pressure-sensitive adhesive that exhibits a peel adhesion of from about 50 g/inch to about 400 g/inch.

Embodiment 23 is the method of embodiment 22 wherein the method comprises coating the pre-adhesive composition as a layer on a major surface of a substrate and irradiating the coated layer of pre-adhesive composition to initiate the crosslinking of the pre-adhesive composition. Embodiment 24 is the method of embodiment 23 wherein the irradiating of the coated layer comprises ebeaming the coated layer. Embodiment 25 is the method of embodiment 23 wherein the irradiating of the coated layer comprises photo-irradiating the coated layer. Embodiment 26 is the method of any of embodiments 22-25 wherein the method includes a first, synthesis reaction in which a monomer mixture comprising (meth)acrylate monomers is polymerized to form the poly(meth)acrylate macromolecules of the pre-adhesive composition. Embodiment 27 is the method of embodiment 26 wherein the first, synthesis reaction to form the pre-adhesive composition is a photo-initiated or thermally initiated synthesis reaction and wherein the crosslinking of the pre-adhesive composition is performed by e-beaming a coated layer of the pre-adhesive composition.

Embodiment 28 is the method of embodiment 26 wherein the first, synthesis reaction to form the pre-adhesive composition is a thermally initiated synthesis reaction and wherein the crosslinking of the pre-adhesive composition is performed by photo-irradiating a coated layer of the pre-adhesive composition. Embodiment 29 is the method of any of embodiments 26-28 wherein the first, synthesis reaction comprises polymerizing the (meth)acrylate monomers in the presence of a chain transfer agent. Embodiment 30 is the method of any of embodiments 22-29 wherein the pre-adhesive composition is a solventless composition.

### Examples

### Materials

Table 1 contains a glossary of raw materials and reagents used. All parts and percentages disclosed herein are on a weight basis, unless otherwise indicated.

TABLE 1

| | |
|---|---|
| IOA | Isooctyl acrylate, monomer; available from Sigma-Aldrich (St. |
| | Louis, MO) |
| EHA | 2-Ethyl hexyl acrylate, monomer; available from Sigma-Aldrich |
| | (St. Louis, MO) |
| DDA | Dodecylacrylate, monomer, obtained from 3M Company |
| EtOAc | Ethyl acetate, solvent; available from VWR (Radnor, PA) |
| IRG651 | 2-dimethoxy-2-phenylacetophenone, photoinitiator, available |
| | from BASF (Florham Park, NJ) under the trade designation |
| | IRGACURE 651 |
| VA67 | 2,2′-azobis-(2-methylbutyronitrile); thermal initiator, |
| | available from DuPont (Wilmington, DE) under the trade |
| | designation VAZO 67 |
| AeBP | Acryloylethoxybenzophenone; photocrosslinker, obtained from |
| | 3M Co. St. Paul, MN |
| IOTG | Isooctyl thioglycolate, chain transfer agent; available from |
| | Sigma-Aldrich (St. Louis, MO) |
| CTG | Caprylic triglyceride, plasticizer; available from Croda Inc. |
| | (Edison, NJ) |
| CMC | Carboxymethylcellulose, obtained from AMTEX, Lombard, IL, |
| | under the trade designation GELYCEL |

### Test Methods

Molecular Weights

Number-average molecular weights (Mₙ) and weight-average molecular weights (M_{w}) were obtained by conventional gel permeation chromatography against EasiCal polystyrene molecular weight standards (Agilent Technologies, Santa Clara, Calif., USA) using tetrahydrofuran as solvent and mobile phase. The equipment consisted of an Agilent 1100 (Pump, degasser, autosampler, column oven, differential refractive index detector) (Agilent Technologies, Santa Clara, Calif., USA) operating at 40° C. and flow rate of 1.0 mL/min. The stationary phase consisted of a Jordi Gel DVB Mixed column (250 mm×10 mm ID) (Jordi Labs, Mansfield, Mass., USA). Molecular weight calculations were performed using Cirrus GPC software from Polymer Labs (now Agilent Technologies, Santa Clara, Calif., USA). The degree of polymerization (DP) of a macromolecule was obtained by dividing M by the molecular weight of the monomer unit (e.g., 184 g/mole for isooctyl acrylate monomer units); contributions of e.g. initiator, crosslinker and/or chain transfer agent were neglected.

Dynamic Mechanical Analysis (DMA)

DMA was used to measure the storage modulus, viscosity, and glass transition temperatures of pre-adhesive compositions. A small sample of pre-adhesive composition was transferred onto the bottom plate of a rheometer (obtained from TA Instruments, New Castle, Del., under the trade designation “ARES G2 RHEOMETER”). The rheometer had 25 mm diameter parallel top and bottom plates. The top plate of the rheometer was brought down onto the sample of pre-adhesive composition until the parallel plates were separated by 1 mm. A temperature sweep test method was used where shear moduli, viscosity, and tan(δ) were estimated while sample was subjected to oscillatory shear (strain amplitude=1%, frequency=1 Hz) and at the same time the sample temperature was continuously increased from −65° C. to 100° C. at a rate of 5° C./min. Storage modulus (G′) was reported in Pa. Viscosity (η) of the pre-adhesive composition was reported in Pascal-seconds (Pa·s). Tan(δ) was calculated as the ratio of G″/G′ (loss modulus/storage modulus). The temperature where the tan(δ) curve had a local peak was reported as the glass transition temperature (“T_{g}”).

Percent Gel

Percent gel (gel content) was determined in generally similar manner as described in ASTM D3616-95 (as specified in 2009), with the following modifications. A test specimen measuring 63/64 inch (2.50 cm) in diameter was die-cut from a tape coated with crosslinked pressure-sensitive adhesive. The specimen was placed in a mesh basket measuring 1.5 inch (˜3.8 cm) by 1.5 inch (˜3.8 cm). The basket with the specimen was weighed to the nearest 0.1 mg and placed in a capped jar containing sufficient amount of EtOAc to cover the sample. After 24 hours the basket (containing the specimen) was removed, drained and placed in an oven at 120° C. for 30 minutes. The percent gel was determined by ratioing the weight of the remaining unextracted portion of the adhesive sample to the weight of the adhesive sample before extraction. (To correct for the weight of the tape backing, a disc of the uncoated backing material of the same size as the specimen was die-cut and weighed.) The formula used for percent gel determination was as shown immediately below:

$$Percent Gel ( wt . \% ) = 100 \times \frac{( unextracted sample wt . after extraction - backing wt . )}{( original sample wt . - backing wt . )}$$

Peel Adhesion Test

Peel adhesion strength was measured at a 1800 angle using an IMASS SP-200 SLIP/PEEL TESTER (available from IMASS, Inc., Accord, Mass.) at a peel rate of 12 inches/minute (305 mm/minute). Stainless steel test panels were prepared by wiping the substrate panels with a laboratory wipe wetted with 2-propanol using hand pressure to wipe the panel 8 to 10 times. This wiping procedure was repeated two more times with clean laboratory wipes wetted with 2-propanol. The cleaned test panels were allowed to air dry for at least 30 minutes.

Adhesive tape samples were cut into strips measuring ½ inch (˜1.27 cm) by 8 inches (˜20 cm), and the strips were rolled down onto the cleaned panel with a 2.0 kg rubber roller using 2 passes. The prepared samples were stored at 23° C. and 50% relative humidity for approximately 1 hour before testing. Peel strengths were reported as average values of 3 to 5 repeated experiments.

### Preparation of Pre-Adhesive Compositions (First, Synthesis Reaction) by Photo-Initiation

Preparation of Pre-Adhesive Composition PRE-1

In a transparent untinted glass jar, 75 g of IOA, 0.38 g of IRG651, 0.37 g of IOTG and 75 g of EtOAc were combined and mixed to form a homogeneous solution. Nitrogen gas was bubbled through the solution for 10 min. through a plastic tube dipped inside the solution. The glass jar was tightly capped. This sealed jar was then placed on a roller and rotated slowly for 40 min. while being exposed to UV lamps (Sylvania 35 Blacklight, Osram Sylvania Inc, Danvers, Mass.) facing down on the roller. After this period of UV exposure, the jars were opened, terminating the polymerization. The resulting pre-adhesive composition PRE-1 was dried by setting the jar containing the polymer solution inside a vacuum oven set at 100° C., until constant weight was observed. The dried pre-adhesive composition was a viscous but flowable liquid, transparent in color.

Preparation of Pre-Adhesive Compositions PRE-2 to PRE-4

Pre-adhesive compositions PRE-2 to PRE-4 were prepared using the same method as described above for PRE-1, except that the amounts of IOA, IRG651, IOTG, and EtOAc were as listed in Table 2.

TABLE 2

| | IOA | | IRG651 | | IOTG | | EtOAc | |
|---|---|---|---|---|---|---|---|---|
| Sample | parts | g | parts | g | parts | g | parts | g |
| PRE-1 | 100 | 75 | 0.5 | 0.38 | 0.49 | 0.37 | 100 | 75 |
| PRE-2 | 100 | 75 | 0.25 | 0.19 | 0.24 | 0.18 | 100 | 75 |
| PRE-3 | 100 | 75 | 0.17 | 0.13 | 0.16 | 0.12 | 100 | 75 |
| PRE-4 | 100 | 75 | 0.14 | 0.10 | 0.1 | 0.08 | 100 | 75 |

Properties for pre-adhesive compositions PRE-1 to PRE-4 were measured according to the test methods described above. DMA test data are shown in FIG. 1; test results are summarized in Table 3.

TABLE 3

| | | | | T_{g}, | G′ @25° C., | η @25° C., |
|---|---|---|---|---|---|---|
| Sample | Mₙ, | M_{w}, | DP | ° C. | Pa | Pa · s |
| PRE-1 | 24,400 | 52,700 | 130 | −48 | 2 | 26 |
| PRE-2 | 27,700 | 84,300 | 151 | −42 | 139 | 200 |
| PRE-3 | 34,400 | 116,000 | 187 | −39 | 798 | 474 |
| PRE-4 | 55,300 | 158,000 | 300 | −36 | 3980 | 1220 |

Preparation of Pre-Adhesive Compositions Comprising Plasticizer

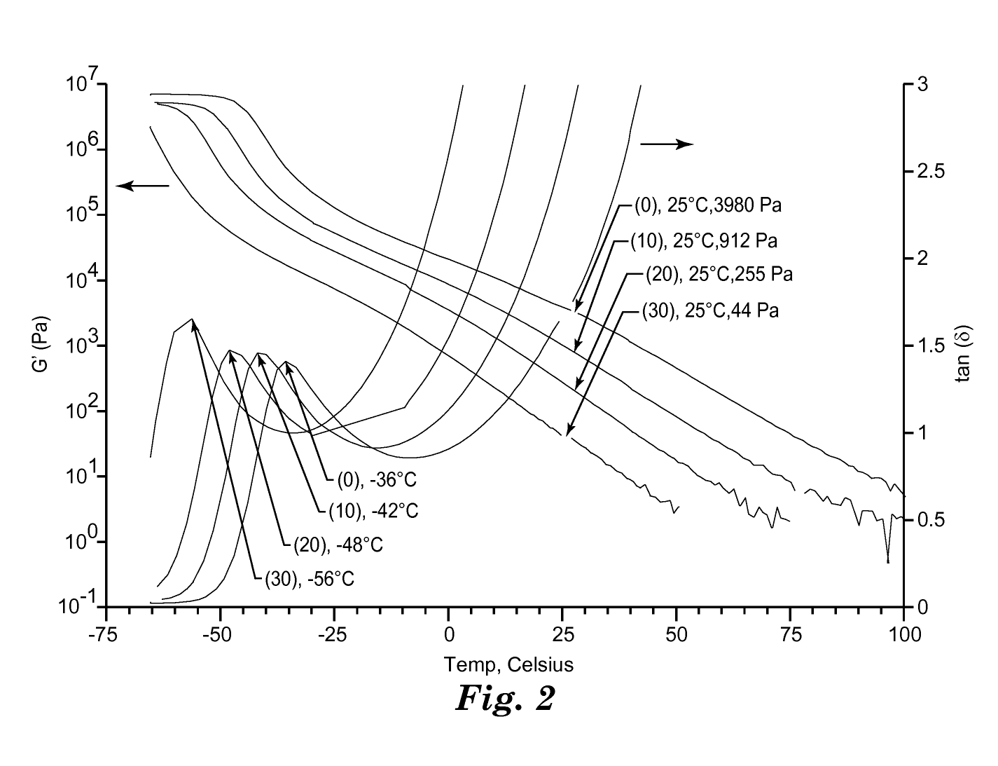

Pre-adhesive composition PRE-4 was dissolved in EtOAc to 50 wt. % solids by combining PRE-4 and the requisite amount of solvent in a jar and rotating the jar for 12 hours at room temperature (ca. 22° C.) to form a homogeneous solution of PRE-4. Caprylic triglyceride (CTG) plasticizer was added dropwise to separate samples of the homogeneous solution of PRE-4, according to the ratios listed in Table 4. EtOAc solvent was then removed under reduced pressure, with heating to 100° C., until constant weight was observed. Properties for pre-adhesive compositions PRE-4 (0), (10), (20), and (30), were measured according to the test methods described above. (In these and all subsequent Samples, numbers in parentheses (xx) indicate the parts of plasticizer per parts of pre-adhesive composition.) DMA test data are shown in FIG. 2; the test results are summarized in Table 4.

TABLE 4

| | PRE-4, | CTG, | T_{g}, | G′ @25° C., | η @25° C., |
|---|---|---|---|---|---|
| Sample | parts | parts | ° C. | Pa | Pa · s |
| PRE-4 (0) | 100 | 0 | −36 | 3980 | 1220 |
| PRE-4 (10) | 90 | 10 | −42 | 912 | 442 |
| PRE-4 (20) | 80 | 20 | −48 | 255 | 207 |
| PRE-4 (30) | 70 | 30 | −56 | 44 | 65 |

### Preparation of Pressure-Sensitive Adhesives (Crosslinking Reaction) by Ebeaming

### Working Example WE-1A

A substrate (backing) was obtained (from DuPont, Wilmington, Del. under the trade designation SONTARA) that was a spunlaced nonwoven web. Pre-adhesive composition PRE-3 was heated to 70° C. for 20 minutes, and then was knife coated by hand as a 4 mil (˜100 micrometers) layer on the substrate. The substrate had a polymer film of 0.8 mil (˜20 micrometers) thickness on one major surface thereof; the pre-adhesive composition was coated on the same side as the polymer film. The layer of coated PRE-3 was subsequently exposed to electron beam irradiation (using an apparatus available under the trade designation CB-300 from Energy Sciences Inc., Wilmington, Mass.), operated at a setting of 230 Kilovolts (kV), to a dose of 16 Megarad (Mrad). This served to crosslink the macromolecules of the pre-adhesive composition thus transforming the pre-adhesive composition into a pressure-sensitive adhesive, thereby providing a pressure-sensitive adhesive tape comprising the nonwoven substrate with a pressure-sensitive adhesive (“PSA”) layer disposed on a major surface thereof.

A test specimen of the Working Example WE-1A pressure-sensitive adhesive tape was tested in the above-described Percent Gel Test, with a resulting gel content of 62.6 wt. %. The Working Example WE-1A pressure-sensitive adhesive tape was tested in the above-described Peel Adhesion Test, with a result of 269 g/inch (106 g/cm).

### Working Examples WE-1B-WE-1D, WE-2, and Comparative Examples

Additional samples of pre-adhesive composition PRE-3 were coated and treated with electron beam irradiation as described in Working Example WE-1A, except that the electron beam irradiation dosages were as summarized in Table 5. Samples of pre-adhesive composition PRE-2 were likewise coated and irradiated at various ebeam dosages, as listed in Table 5. Samples of pre-adhesive composition PRE-1 were also coated and irradiated at various ebeam dosages. However, for samples using pre-adhesive composition PRE-1, the ebeam irradiation did not appear to produce an adequately networked product (judging e.g. by the amount of residue left behind when the crosslinked polymer product was bonded and then debonded from a test surface). It thus appeared that the molecular weight of the PRE-1 pre-adhesive composition (approximately 24,400) was too low to produce an acceptable pressure-sensitive adhesive when crosslinked. Accordingly, samples made from pre-adhesive composition PRE-1 are labeled Comparative Examples herein.

180° Peel Adhesion test data are listed in Table 5 for the Working Example samples made from pre-adhesive compositions PRE-3 and PRE-2.

TABLE 5

| | Pre-adhesive | E-beam, | Peel Adhesion, |
|---|---|---|---|
| PSA Sample | composition | Mrad | g/inch (g/cm) |
| WE-1A | PRE-3 | 16 | 269 (106) |
| WE-1B | PRE-3 | 14 | 352 (139) |
| WE-1C | PRE-3 | 12 | 302 (119) |
| WE-1D | PRE-3 | 10 | 249 (98) |
| WE-2A | PRE-2 | 26 | 442 (174) |
| WE-2B | PRE-2 | 24 | 330 (130) |
| WE-2C | PRE-2 | 22 | 380 (150) |
| WE-2D | PRE-2 | 20 | 344 (135) |
| CE*-1A | PRE-1 | 36 | ND** |
| CE-1B | PRE-1 | 32 | ND |
| CE-1C | PRE-1 | 28 | ND |

*“CE” = Comparative Example;
**“ND” = Not Determined

In addition to Peel Adhesion tests from a test substrate (stainless steel), PSAs were also subjected to qualitative skin adhesion testing. Many such PSA samples exhibited good ability to bond to skin, and yet were able to be removed therefrom with a gentle feel (i.e., with a minimum of perceived discomfort reported by human volunteers). In particular, Working Example WE-1A exhibited excellent properties of this general nature, and was also able to be rebonded to skin several times after being removed therefrom.

### Working Example PSAs Comprising Plasticizer

Samples of pre-adhesive composition PRE-4 (10), PRE-4 (20), and PRE-4 (30), comprising various amounts of plasticizer as noted above, were coated onto a backing and treated with electron beam irradiation as described in Working Example WE-1A. The ebeam dosages used varied from 16 to 28 Mrad. In qualitative testing, the resulting PSA's typically displayed a gentle feel in removal from human skin, with slightly more residue being noted at the highest levels of plasticizer.

### Pre-Adhesive Compositions and Working Example PSAs Using Other Monomers

Preparation of Pre-Adhesive Composition PRE-5 and PRE-5 (10)

A composition PRE-5 was made by the same method used for PRE-3, except that the monomer used was EHA (instead of IOA). Plasticizer (CTG) was then added to form a pre-adhesive composition PRE-5 (10) using the same method as used for PRE-4 (10).

Preparation of Pre-Adhesive Composition PRE-6 and PRE-6 (10)

A composition PRE-6 was made by the same method used for PRE-3, except that the monomer used was DDA (instead of IOA), and that the ratio of reactants were as shown in Table 6. Plasticizer (CTG) was then added to form a pre-adhesive composition PRE-6 (10) using the same method as used for PRE-4 (10).

TABLE 6

| | DDA | | IRG651 | | IOTG | | EtOAc | |
|---|---|---|---|---|---|---|---|---|
| Sample | parts | g | parts | g | parts | g | parts | g |
| PRE-6 | 100 | 75 | 0.15 | 0.1125 | 0.1 | 0.075 | 100 | 75 |

### Working Example WE-3

A PSA Sample WE-3 was made in the same method as WE-1A, except that pre-adhesive composition PRE-5 (10) was used, the knife coating gap during coating was set at 7 mils, and the ebeam setting was 200 KV. The resulting Working Example WE-3 pressure-sensitive adhesive tape was tested in the above-described Peel Adhesion Test, with a result of 276 g/inch (109 g/cm).

### Working Example WE-4

A PSA Sample WE-4 was made in the same method as WE-1A, except that pre-adhesive PRE-6 (10) was used, the knife coating gap during coating was set at 7 mils, and the ebeam setting was 240 KV. The resulting Working Example WE-4 pressure-sensitive adhesive tape was tested in the above-described Peel Adhesion Test, with a result of 194 g/inch (77 g/cm).

TABLE 7

| | Pre-adhesive | E-beam, | Peel Adhesion, |
|---|---|---|---|
| PSA Sample | composition | Mrad | g/inch (g/cm) |
| WE-3 | PRE-5 (10) | 16 | 276 (109) |
| WE-4 | PRE-6 (10) | 16 | 194 (77) |

### Pre-Adhesive Compositions and Working Example PSAs Including Hydrocolloids

Preparation of Pre-Adhesive Composition Series PRE-7

A composition PRE-7 was made by the same method, and of approximately the same composition, as PRE-3. 10 parts plasticizer (CTG) was then added to composition PRE-7 by the same method as used to make composition PRE-4 (10). Composition PRE-7 (10) was mixed with hydrocolloid (CMC) at various proportions, to form various hydrocolloid-containing pre-adhesive compositions as shown in Table 8 below. The pre-adhesive compositions were rolled over rollers for 6 hours. (In all samples below, the parts of hydrocolloid in the pre-adhesive composition are shown in square brackets [yy]; the parts of plasticizer are shown in parentheses.)

TABLE 8

| Sample | PRE-7 (10), parts | CMC, parts |
|---|---|---|
| PRE-7 (10) [0] | 100 | 0 |
| PRE-7 (10) [5] | 100 | 5 |
| PRE-7 (10) [10] | 100 | 10 |
| PRE-7 (10) [15] | 100 | 15 |
| PRE-7 (10) [20] | 100 | 20 |

### Working Examples WE-5A to WE-5E

PSA Samples WE-5A to WE-5E were made by the same method as used for Sample WE-1A, except that the knife coating gap during coating was set at 7 mils (instead of 4 mils). The Working Examples adhesive tapes were tested in the above-described Peel Adhesion Test, with results shown as below:

TABLE 9

| | Pre-adhesive | E-beam, | Peel Adhesion, |
|---|---|---|---|
| PSA Sample | composition | Mrad | g/inch (g/cm) |
| WE-5A | PRE-7 (10) [0] | 16 | 282 (111) |
| WE-5B | PRE-7 (10) [5] | 16 | 299 (118) |
| WE-5C | PRE-7 (10) [10] | 16 | 293 (115) |
| WE-5D | PRE-7 (10) [15] | 16 | 294 (116) |
| WE-5E | PRE-7 (10) [20] | 16 | 248 (98) |

### Preparation of Pre-Adhesive Compositions (First, Synthesis Reaction) by Thermal Initiation

Preparation of Pre-Adhesive Composition PRE-101

In a tinted glass jar, 100 parts (grams) of IOA monomer, 0.4 g of AeBP, 0.14 g of VA67, 0.14 g of IOTG, and 100 g of EtOAc were combined to form a reaction mixture. The mixture was well mixed using a shaker and formed a homogenous solution. Nitrogen gas was bubbled through the solution for 10 minutes. The cap of the jar was tightened and the jar was put in a launderomater containing water maintained at a setpoint of 60° C. and the reaction was allowed to proceed. After approximately 24 hours of reaction time, the glass jar was removed from the launderomater and opened to allow air/oxygen to enter the jar, thereby terminating the reaction.

Preparation of Pre-Adhesive Compositions PRE-102 to PRE-107

Pre-adhesive compositions PRE-102 to PRE-107 were prepared using the same method as described above for PRE-101, except that the parts of IOA, AeBP, VA67, IOTG, and EtOAc were as listed in Table 10. (Samples 106i-106v differed only in the amount of AeBP.)

TABLE 10

| Sample | IOA | AeBP | VA67 | IOTG | EtOAc |
|---|---|---|---|---|---|
| PRE-101 | 100 | 0.4 | 0.14 | 0.14 | 100 |
| PRE-102 | 100 | 0.2 | 0.2 | 0.15 | 100 |
| PRE-103 | 100 | 0.15 | 0.2 | 0.15 | 100 |
| PRE-104 | 100 | 0.1 | 0.2 | 0.15 | 100 |
| PRE-105 | 100 | 0.2 | 0.2 | 0.23 | 100 |
| PRE-106i | 100 | 0.2 | 0.2 | 0.35 | 100 |
| PRE-106ii | 100 | 0.4 | 0.2 | 0.35 | 100 |
| PRE-106iii | 100 | 0.6 | 0.2 | 0.35 | 100 |
| PRE-106iv | 100 | 0.8 | 0.2 | 0.35 | 100 |
| PRE-106v | 100 | 1 | 0.2 | 0.35 | 100 |
| PRE-107 | 100 | 0.2 | 0.2 | 0.55 | 100 |

Molecular weights and degrees of polymerization for pre-adhesive compositions PRE-101 to PRE-107 were measured according to the test methods described above and are summarized in Table 11.

TABLE 11

| Sample | Mₙ | M_{w} | DP |
|---|---|---|---|
| PRE-101 | 71,300 | 242,000 | 388 |
| PRE-102 | 57,900 | 174,000 | 315 |
| PRE-103 | 56,600 | 164,000 | 308 |
| PRE-104 | 55,100 | 168,000 | 299 |
| PRE-105 | 57,900 | 163,000 | 315 |
| PRE-106i | 43,100 | 106,000 | 234 |
| PRE-106ii | 34,500 | 86,000 | 188 |
| PRE-106iii | 31,700 | 89,000 | 172 |
| PRE-106iv | 33,400 | 84,000 | 182 |
| PRE-106v | 32,400 | 82,000 | 176 |
| PRE-107 | 32,100 | 76,000 | 175 |

### Preparation of Pressure-Sensitive Adhesives (Crosslinking Reaction) by Photo-Crosslinking

### Working Example WE-101

90 parts of pre-adhesive composition PRE-106iii were mixed with 10 parts of CTG plasticizer until a homogenous solution was obtained. The solution was then coated manually, with a laboratory knife coater with a coating gap of approximately 10 mils, onto a tape backing of the type found in the product available in 2014 from 3M Company, St. Paul Minn. under the trade designation KIND REMOVAL SILICONE TAPE. The coated tape backing was then placed (coating side up) in an oven for 70° C. for twenty minutes to remove the solvent. After this, the coated tape backing was exposed to high intensity UV radiation (UV-B, “D” bulb) for a total dose of approximately 270 mJ/cm². The resulting pressure-sensitive adhesive tape was found to exhibit a Peel Adhesion of approximately 220 grams/inch.

Preparation of Solventless Pre-Adhesive Composition

A reaction mixture was prepared with 100 parts IOA, 0.3 parts AeBP, 0.16 parts IOTG, and various thermal initiators and antioxidants. The reaction mixture was reacted in a first reaction step, after which various additional thermal initiators and antioxidants were added and a second reaction step was performed. (The combinations of thermal initiators and antioxidants and two-step procedure that was used, followed the general teachings outlined in the Examples of U.S. Pat. No. 7,968,661 to Ellis.) The AeBP and certain thermal initiators were provided in EtOAc to ensure that they were dissolved, thus a very small amount of solvent was present in this nominally solventless reaction mixture. The thus-produced pre-adhesive composition had a molecular weight (Ma) of approximately 75,400 grams per mole.

The pre-adhesive composition was dried in a vacuum oven at 100° C. for two hours, after which it was dissolved in EtOAc at approximately 50% solids. (The composition was dissolved in solvent for ease of hand-coating without needing to heat the composition for coating.) 90 parts of this pre-adhesive composition was mixed with 10 parts of CTG plasticizer until a homogenous solution was obtained. The solution was then coated manually, with a laboratory knife coater with a coating gap of approximately 3 mils, onto a tape backing. The coated tape backing was then placed (coating side up) in an oven for 70° C. for twenty minutes to remove the solvent. After this, the coated tape backing was exposed to high intensity UV radiation (UV-B D bulb) for a total dose of approximately 180 mJ/cm². The resulting pressure-sensitive adhesive tape was found to exhibit a Peel Adhesion of approximately 163 grams/inch. The PSA was also subjected to qualitative skin adhesion testing, and was found to evoke a feeling that was gentle on skin during removal.

The foregoing Examples have been provided for clarity of understanding only, and no unnecessary limitations are to be understood therefrom. The tests and test results described in the Examples are intended to be illustrative rather than predictive. All quantitative values in the Examples are understood to be approximate in view of the commonly known tolerances involved. It will be apparent that the specific exemplary elements, structures, features, details, configurations, etc., that are disclosed herein can be modified and/or combined in numerous embodiments. All such variations and combinations are contemplated by the inventor as being within the bounds of the conceived invention, not merely those representative designs that were chosen to serve as exemplary illustrations. Thus, the scope of the present invention should not be limited to the specific illustrative structures described herein, but rather extends at least to the structures described by the language of the claims, and the equivalents of those structures. Any of the elements that are positively recited in this specification as alternatives may be explicitly included in the claims or excluded from the claims, in any combination as desired. Any of the elements or combinations of elements that are recited in this specification in open-ended language (e.g., comprise and derivatives thereof), are considered to additionally be recited in closed-ended language (e.g., consist and derivatives thereof) and in partially closed-ended language (e.g., consist essentially, and derivatives thereof). To the extent that there is a conflict or discrepancy between this specification as written and the disclosure in any document incorporated by reference herein, this specification as written will control.

1. A pressure-sensitive adhesive, comprising:
the crosslinking reaction product of a pre-adhesive composition comprising poly(meth)acrylate macromolecules that comprise a number-average molecular weight of from about 25000 to about 200000, wherein the pre-adhesive composition exhibits a T_{g} of less than about minus 20° C., exhibits a storage modulus of from about 4 Pa to about 10000 Pa at 25° C., and wherein the pressure-sensitive adhesive exhibits a peel adhesion of from about 50 g/inch to about 400 g/inch.

2. The adhesive of claim 1 wherein the poly(meth)acrylate macromolecules comprise a number-average molecular weight of from about 25000 to about 100000.

3. The adhesive of claim 1 wherein the poly(meth)acrylate macromolecules comprise a number-average molecular weight of from about 25000 to about 40000.

4. The adhesive of claim 1 wherein the pre-adhesive composition exhibits a storage modulus of from about 100 Pa to about 1000 Pa.

5. (canceled)

6. The adhesive of claim 1 the pre-adhesive composition exhibits a T_{g} of less than about minus 45° C.

7. The adhesive of claim 1 wherein the pre-adhesive composition exhibits a viscosity from about 10 Pa·s to about 800 Pa·s at 25° C.

8. The adhesive of claim 1 wherein the poly(meth)acrylate macromolecules make up at least about 95 wt. % of the macromolecular components of the pre-adhesive composition.

9. (canceled)

10. (canceled)

11. The adhesive of claim 1 wherein the poly(meth)acrylate macromolecules consist essentially of alkyl (meth)acrylate monomer units.

12. The adhesive of claim 1 wherein the poly(meth)acrylate macromolecules of the pre-adhesive composition are substantially linear macromolecules.

13. The adhesive of claim 1 wherein the pre-adhesive composition further comprises from about 4 wt. % to about 30 wt. % of a plasticizer, based on the total weight of the pre-adhesive composition.

14. The adhesive of claim 1 wherein the poly(meth)acrylate macromolecules are the reaction product of a first, synthesis reaction of a monomer mixture that included at least one chain transfer agent and wherein at least some of the poly(meth)acrylate macromolecules include at least one chain transfer agent residue.

15. The adhesive of claim 1 wherein the pressure-sensitive adhesive exhibits a gel content of from about 40 to about 70%.

16. The adhesive of claim 1 wherein the pressure-sensitive adhesive is an e-beam crosslinking reaction product of the pre-adhesive composition.

17. The adhesive of claim 1 wherein the pressure-sensitive adhesive is a photo-crosslinking reaction product of the pre-adhesive composition and wherein at least some of the poly(meth)acrylate macromolecules of the crosslinked reaction product include at least one photo-activatable crosslinker residue.

18. The adhesive of claim 1 wherein the pressure-sensitive adhesive exhibits interfacial debonding in a Peel Adhesion test.

19. A pressure-sensitive adhesive tape comprising a backing with a pressure-sensitive adhesive disposed on a major surface thereof, wherein the pressure-sensitive adhesive is the crosslinking reaction product of a pre-adhesive composition comprising poly(meth)acrylate macromolecules that comprise a number-average molecular weight of from about 25000 to about 200000, wherein the pre-adhesive composition exhibits a T_{g} of less than about minus 20° C. and exhibits a storage modulus of from about 4 Pa to about 10000 Pa at 25° C., and wherein the pressure-sensitive adhesive tape exhibits a peel adhesion of from about 50 g/inch to about 400 g/inch.

20. The pressure-sensitive adhesive tape of claim 19 wherein the pressure-sensitive adhesive is in the form of a layer with an average thickness of about 130 microns or less.

21. A method of bonding a pressure-sensitive adhesive tape to skin, the method comprising applying the pressure-sensitive adhesive of the pressure-sensitive adhesive tape of claim 19 to skin.

22. A method of making a pressure-sensitive adhesive, the method comprising:
crosslinking a pre-adhesive composition comprised of poly(meth)acrylate macromolecules that comprise a number-average molecular weight of from about 25000 to about 200000, which pre-adhesive composition exhibits a T_{g} of less than about minus 20° C. and a storage modulus of from about 4 to about 10000 Pa at 25° C., to form a pressure-sensitive adhesive that exhibits a peel adhesion of from about 50 g/inch to about 400 g/inch.

23. The method of claim 22 wherein the method comprises coating the pre-adhesive composition as a layer on a major surface of a substrate and irradiating the coated layer of pre-adhesive composition to initiate the crosslinking of the pre-adhesive composition.

24.-25. (canceled)

26. The method of claim 22 wherein the method includes a first, synthesis reaction in which a monomer mixture comprising (meth)acrylate monomers is polymerized to form the poly(meth)acrylate macromolecules of the pre-adhesive composition.

27. The method of claim 26 wherein the first, synthesis reaction to form the pre-adhesive composition is a photo-initiated or thermally initiated synthesis reaction and wherein the crosslinking of the pre-adhesive composition is performed by e-beaming a coated layer of the pre-adhesive composition.

28. The method of claim 26 wherein the first, synthesis reaction to form the pre-adhesive composition is a thermally initiated synthesis reaction and wherein the crosslinking of the pre-adhesive composition is performed by photo-irradiating a coated layer of the pre-adhesive composition.

29.-30. (canceled)
